(19) United States
(12) Patent Application Publication
(10) Pub. No.: US 2013/0018650 A1
(43) Pub. Date: Jan. 17, 2013

(54) Selection of Language Model Training Data

(71) Applicants: Robert Carter Moore, Mercer Island, WA (US); William Duncan Lewis, Seattle, WA (US)

(72) Inventors: Robert Carter Moore, Mercer Island, WA (US); William Duncan Lewis, Seattle, WA (US)

(73) Assignee: MICROSOFT CORPORATION, Redmond, WA (US)

(21) Appl. No.: 13/363,401

(22) Filed: Feb. 1, 2012

Related U.S. Application Data
(60) Provisional application No. 61/506,566, filed on Jul. 11, 2011.

(51) Int. Cl. G06F 17/27

(52) U.S. Cl. 704/9

(57) ABSTRACT

An intelligent selection system selects language model training data to obtain in-domain training datasets. The selection is accomplished by estimating a cross-entropy difference for each candidate text segment from a generic language dataset. The cross-entropy difference is a difference between the cross-entropy of the text segment according to the in-domain language model and the cross-entropy of the text segment according to a language model trained on a random sample of the data source from which the text segment is drawn. If the difference satisfies a threshold condition, the text segment is added as an in-domain text segment to a training dataset.

### CROSS REFERENCE TO RELATED APPLICATIONS

This application takes priority from U.S. Provisional Patent Application No. 61/506,566 filed on Jul. 11, 2011 and entitled “Selection of Language Model Training Data,” which is specifically incorporated herein by reference for all that it discloses and teaches.

### BACKGROUND

Statistical N-gram language models are widely used in applications that produce natural-language text as output, particularly in speech recognition and machine translation. Such language models are built from training data. Generally, language models are general purpose and therefore are not necessarily trained on domain-specific data. However, for various domain-specific applications, using domain-specific training data to train the language model can result in improved quality of the language models. For example, a language model related to the legal domain can be trained using a large number of legal cases. It is expected that a larger amount of training data results in a more accurate language model. Therefore, often non-domain-specific data is used to augment the in-domain training data. Thus, data from business publications is used to augment the training data for the legal domain language model. However, the relationship between the training data and the output domain (e.g., the desired output) significantly influences the accuracy of the language model. Accordingly, the language model accuracy can be improved by selecting a subset of available data as the training data to train a language model.

### SUMMARY

Implementations described and claimed herein address the foregoing problems by scoring a data segment from a non-domain-specific dataset based on a difference between a cross-entropy of the data segment according to an in-domain language model and a cross-entropy of the data segment according to a non-domain-specific language model. Thus, for a language model used in the legal domain, the implementations described herein select text segments from a non-legal domain, such as a dataset of business articles, for augmenting the training data for the legal domain language model. An implementation of the system determines an in-domain cross-entropy of a particular text segment from a non-domain-specific dataset, the business dataset, according to an in-domain language model, the legal language model. The system also determines a non-domain-specific cross-entropy of the particular text segment according to a non-domain-specific language model, which is based on the business dataset. Subsequently, a difference between the in-domain cross-entropy and the non-domain-specific cross-entropy for the particular text segment from the business dataset is calculated and such difference is evaluated against a threshold value. If the difference for the particular text segment from the business dataset satisfies the threshold condition, the text segment is added to the training data for the in-domain language model, such as the legal domain language model.

In some implementations, articles of manufacture are provided as computer program products. One implementation of a computer program product provides a tangible computer program storage medium readable by a computing system and encoding a processor-executable program.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates example data sources and flows for selecting training data for a language model.

FIG. 2 illustrates alternative example data sources and flows for selecting training data for a language model.

FIG. 3 illustrates example operations for selecting in-domain training data for a language model.

FIG. 4 illustrates an example machine translation system using various language models trained using the training data.

FIG. 5 illustrates an example system that may be useful in implementing the technology described herein.

### DETAILED DESCRIPTIONS

Data for training a language model can be collected from many sources and may or may not be related to the language model's desired application. Generally, a larger size of the training data results in better performance of the language model. However, the language model can be made more accurate if the training data is well matched to the desired application. Thus, training a language model using in-domain training data results in a language model that is better matched to the domain of interest (e.g., as measured in terms of perplexity or entropy on held-out in-domain data). For example, a language model used in a healthcare setting that is trained using training data from healthcare related sources is likely to be more accurate than a language model trained using training data from generic sources (e.g., language data from arbitrary data sources).

A domain for a language model can be based on any category of data sharing a common usage characteristic, including without limitation the vocabulary associated with a particular language (e.g., English, Hindi, Romanized Hindi, etc.) or data related to a shared speech pattern or dialect (e.g., American English, Australian English, etc.). Alternatively, a language model can be based on any category of data sharing a common area of knowledge (e.g., legal language, technical language, medical language, language about a particular type of product or service, etc.).

The use of in-domain training data also reduces the computational resources employed to exploit a large amount of non-domain-specific data, as fewer resources are needed to use a large amount of non-domain-specific data to define a smaller in-domain training dataset than those used to build a language model from the large amount of non-domain-specific training data. However, using a larger amount of training data to train a language model improves the efficacy of the language model. Therefore, it is advantageous to augment training data with data from non-domain-specific data sources as long as such data is well matched to the desired application.

The implementations disclosed herein also provide an efficient method for increasing the size of the in-domain training data for a language model by selecting data segments from an out-of domain dataset. For example, an implementation augments the in-domain training data that is used for training healthcare related models by selecting text segments from a parallel sentence dataset that includes various sentences related to healthcare in-two different languages. An example of such a parallel dataset is a dataset in French language that includes a number of healthcare related articles translated to from a set of healthcare related articles in English. When the parallel sentence dataset is in a language other than the language of the in-domain data, filtering such parallel sentence dataset can be used augment the in-domain dataset. Specifically, such filtered segments from the parallel dataset in another language can be used to train a translational model that is used for providing translations between two languages.

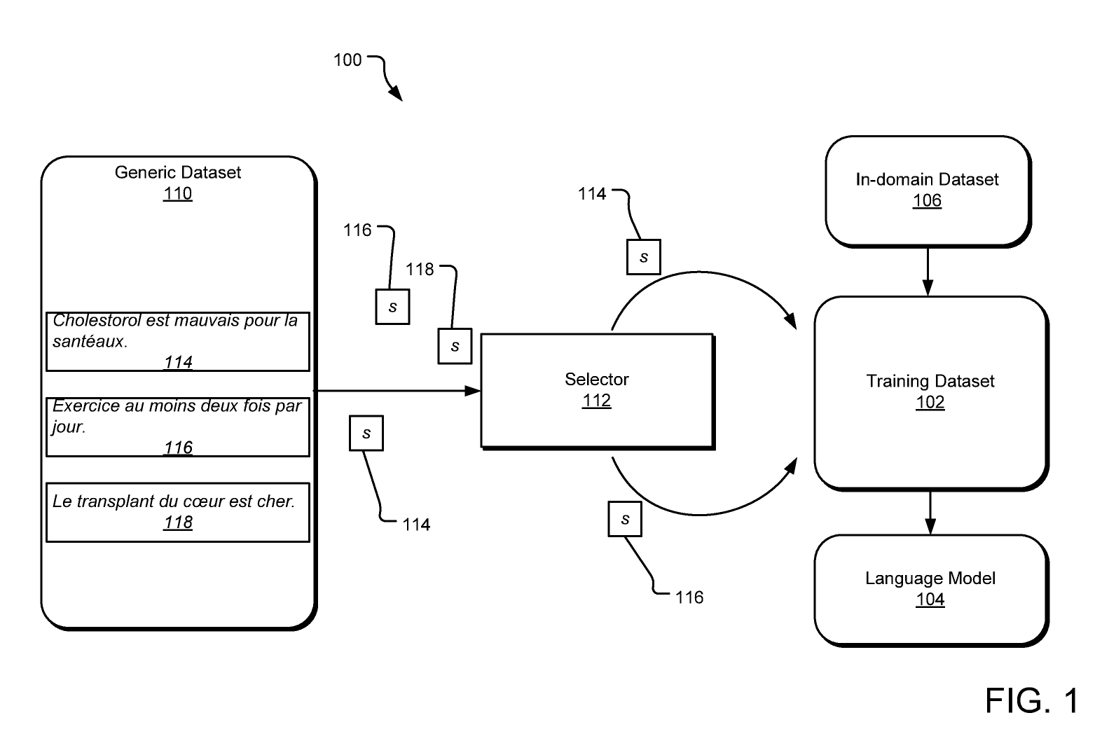

FIG. 1 illustrates an example system 100 for selecting the training data for an in-domain training dataset 102. For example, the in-domain training dataset 102 includes training data for a language model 104, such as an in-domain language model used in the healthcare industry. Generally, the training data for training the language model 104 is selected from an in-domain dataset 106. For example, for the language model 104 related to healthcare, such in-domain dataset 106 includes data with healthcare industry related terminology, transcripts, articles, etc. Thus, the training dataset 102 includes various text segments selected from such healthcare industry related transcripts, articles, etc.

However, to increase the accuracy and efficacy of the language model 104, an implementation of the system 100 also selects text segments from a generic dataset 110. For example, the generic or non-domain-specific language dataset 110 is database of healthcare related articles in French including a large number of text segments, including text segments 114, 116, and 118 representing various sentences in the French language. Other examples of the generic or non-domain-specific language dataset 110 include healthcare related product manuals, localized content for help sites and knowledge bases, phrasebooks, multilingual sites for large international concerns or government agencies, etc. Assuming that enough in-domain language data exists in the in-domain dataset 106 to train a reasonably accurate in-domain language model 104, then this in-domain language model 104 is also used to score various text segments from other data sources, such as the generic dataset 110. Subsequently, text segments from the generic dataset 110 with scores that meet a threshold are included into the training dataset 102.

A selector 112 evaluates each of the text segments 114, 116, and 118 to determine whether that text segment should be added to the training dataset 102 for the language model 104. In one implementation, to evaluate a particular text segment, the selector 112 determines an in-domain cross-entropy of that particular text segment according to an in-domain language model 104 and a non-domain-specific cross-entropy of the text segment according to a non-domain-specific language model. Thus, for example, to evaluate whether the text segment 114 should be included in the training dataset 102, the selector 112 determines the in-domain cross-entropy of the text segment 114 according to the language model 104 and the non-domain-specific cross-entropy of the text segment 114 according to a non-domain-specific language model based on the generic dataset 110. In one implementation, such non-domain-specific language model based on the generic dataset 110 is a language model trained on a random sample of text segments from the generic dataset 110.

We define the cross-entropy H_{M}(s) of a text segment s according to a language model M as:

$${H}_{M} ( s ) = - \frac{1}{N} {\sum }_{i = 1}^{N} log ( {P}_{M} ( {s}_{i} \vert {s}_{0} , … , {s}_{i - 1} ) )$$

In this equation s consists of a sequence of tokens s₁, . . . , s_{N}, and s₀ is an artificial token indicating the beginning of the segment. In one implementation, s_{N} is an artificial token, indicating the end of the segment. P_{M} is the conditional probability distribution, defined by M, estimating the probability of each token in a text segment, given the sequence of the preceding tokens.

In one implementation, each of the individual text segments 114, 116, 118 is scored based on a difference between the in-domain cross-entropy of that text segment according to the in-domain language model 104 and the non-domain-specific cross-entropy of that text segment according to the language model trained on a random sample of the dataset 110.

To state this formally, let/be an in-domain dataset 106 and N be a non-domain-specific (or otherwise not entirely in-domain) dataset 110. Also, let H_{I}(s) represent the per-word cross-entropy of a text segment s (such as 114, 116, 118) drawn from N, according to a language model trained on I and referred to as the in-domain cross-entropy. Let H_{N}(s) represent the per-word cross-entropy of s, according to a language model trained on a random sample of N and referred to as the non-domain-specific cross-entropy. Using these concepts, one may partition N into text segments (e.g., sentences, pair of words) and calculate a cross-entropy difference Δ for each of the text segments according to cross-entropy difference Δ=H_{I}(s)−H_{N}(s). Subsequently, all text segments having a cross-entropy difference Δ that score less than a threshold T are selected for being included in the training dataset 102.

In an implementation, the threshold T is set arbitrarily to a particular cut-off, and then changed based on experimentation (e.g., training machine translation engines and testing the quality of resulting output). In alternative implementation, other thresholding methods are employed.

Thus, for example, the selector 112 determines the cross-entropy difference Δ between the in-domain cross-entropy H_{I}(s) for the text-segment 114 and the non-domain-specific cross-entropy H_{N}(s) of the text segment 114. The selector 112 then evaluates this cross-entropy difference Δ for the text segment 114 using a threshold condition. For example, given a threshold T, if the cross-entropy difference Δ for the text-segment 114 is less than the threshold T, then the selector 112 selects that text segment 114 for inclusion in a training dataset 102. On the other hand, if the cross-entropy difference Δ for the text-segment 114 is greater than or equal to the threshold T, then the selector 112 does not select the text segment 114 for inclusion in a training dataset 102.

The selector 112 evaluates each of the text segments 114, 116, 118 in the manner discussed above. FIG. 1 shows that the text segments 114 and 116 have a cross-entropy difference less than the threshold T, and therefore, the selector 112 selects them for input to the training dataset 102 for the language model 104. On the other hand, the cross-entropy difference for the text segment 118 is greater than the threshold T, and therefore, the selector 112 does not select it for input to the training dataset 102 for the language model 104.

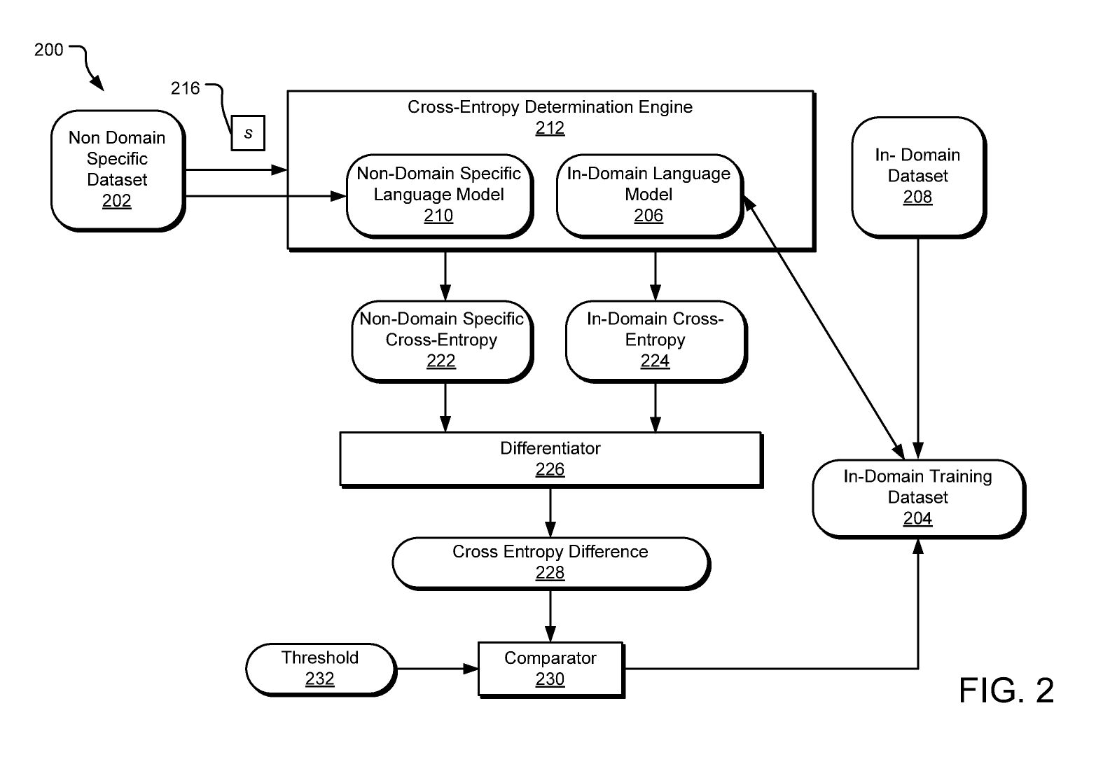

FIG. 2 illustrates alternative example data sources and flows for selecting the training data for a language model. Specifically, FIG. 2 illustrates a system 200 for selecting data segments from a non-domain-specific dataset 202 for augmenting a training dataset 204. The training dataset 204 includes data segments used for training an in-domain language model 206. The training dataset 204 also includes various data segments from an in-domain dataset 208. For example, the in-domain dataset 208 is a speech recognition related dataset including transcriptions of various healthcare related audio recordings. The in-domain language model 206 is trained using the data segments from the in-domain training dataset 204. An example of the non-domain-specific dataset 202 is an audio translation database that provides translation for various words between two languages. A non-domain-specific language model 210 is trained on the non-domain-specific dataset 202.

The system 200 includes a cross-entropy determination engine 212 that calculates cross-entropy for the various data segments in the non-domain-specific dataset 202. For example, the determination engine 212 evaluates a data segment 216, such as a sentence translation between two languages, to see if such a data segment 216 should be included in the training dataset 204. Specifically, the determination engine 212 uses a non-domain-specific language model 210 to determine a non-domain-specific cross-entropy 222. Similarly, the determination engine 212 uses the in-domain language model 206 to determine an in-domain cross-entropy 224.

The system 200 also includes a differentiator 226 that calculates a cross-entropy difference 228 between the non-domain-specific cross-entropy 222 and the in-domain cross-entropy 224. In one implementation, the cross-entropy difference is a log space difference between the non-domain-specific cross-entropy 222 and the in-domain cross-entropy 224. A comparator 230 compares the cross-entropy difference 228 to a threshold value 232 to determine whether the data segment 216 should be added to the in-domain training dataset 204. Specifically, the comparator 230 determines if the value of the cross-entropy difference 228 is less than or equal to a threshold T. If so, the data segment 216 is added to the in-domain training dataset 204. However, if the value of the cross-entropy difference 228 is greater than the threshold T, the data segment 216 is not added to the in-domain training dataset 204.

While the in-domain language model 206 and the non-domain-specific language model 210 disclosed in FIG. 2 are speech recognition language models, in an alternative implementation, other language models, such as an n-gram based statistical language model, a bar code searching language model, a QR code searching language model, a search algorithm related language model, a biological sequencing language model, etc., can be used. Depending on the type of the language model used by the system 200, the data segment 216 also varies. For example, if the system 200 is using a biological sequencing language model, the data segment 216 is a segment of a biological sequence, etc.

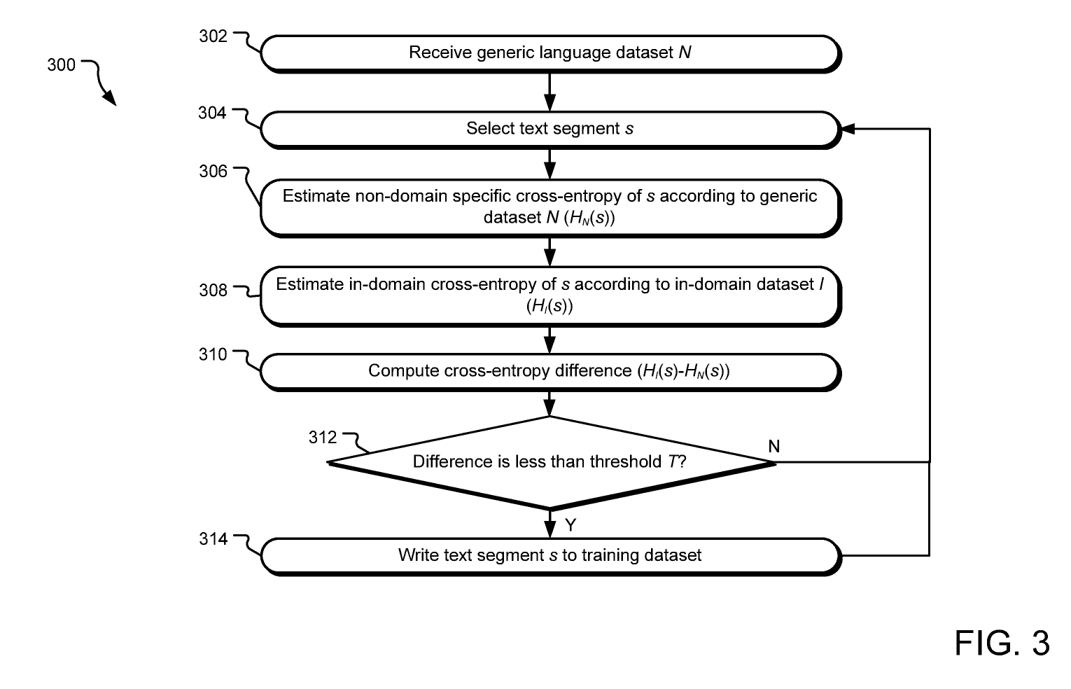

FIG. 3 illustrates example operations 300 for selecting the in-domain training data for a language model. For example, the in-domain training data is the training data for a healthcare technology related language model. A receiving operation 302 receives a generic language dataset N. For example, the generic language dataset N is a dataset based on a large number of Internet searches related to technology in general. The operations 300 are used to extract data segments from the generic language dataset N for the in-domain training data for a language model.

A selection operation 304 selects a data segment s from the generic language dataset N. In one implementation, the selection operation 304 exhausts all segments in the generic language dataset N so as to extract substantially all potential “in-domain” segments. Subsequently, if fewer segments are desired, the selection operation 304 samples the extracted dataset for segments. However, in an implementation, the selection operation 304 selects the data segment s from the generic language dataset N randomly. However, in an alternative implementation, the selection operation 304 selects the data segment s based on a specific algorithm. For example, the selection operation 304 selects the data segment s based on a frequency of usage information related to the generic language dataset N. However, in an alternate implementation, another ranking or selection algorithm is used.

An initial estimation operation 306 estimates a non-domain-specific cross-entropy H_{N}(s) of the data segment s according to the generic language dataset N. Another estimation operation 308 estimates an in-domain cross-entropy H_{I}(s) of the data segment s, which represents an independently developed in-domain dataset. For example, the dataset I includes corpora known to be in a particular domain, such as the domain of healthcare related technology. In one implementation, such in-domain language dataset I is purchased for specific domains, such as the healthcare technology domain. For example, MedSearch™ provides domain-specific data related to medical technology domain. Another example of a domain-specific corpus is Gigaword corpus, which is known to be in the news domain. In an alternative implementation, the in-domain language dataset I is generated based on searches from a particular set of websites known to be in a particular domain (e.g., medical sites, technology websites, etc.).

A difference operation 310 computes the cross-entropy difference Δ between the in-domain cross-entropy H_{I}(s) and the non-domain-specific cross-entropy H_{N}(s). Subsequently, a decision operation 312 determines whether the cross-entropy difference Δ is less than a predetermined threshold T. If the cross-entropy difference Δ is determined to be less than the threshold T, the data segment s that satisfied the threshold condition is added to the training dataset. Subsequently, the processing returns to the selection operation 304 to select a new candidate data segment s. However, if the decision operation 312 determines the cross-entropy difference Δ to be greater than the threshold T, the data segment s that did not satisfy the threshold condition is not added to the training dataset. In this case, the processing returns to the selection operation 304 to select a new candidate data segment s.

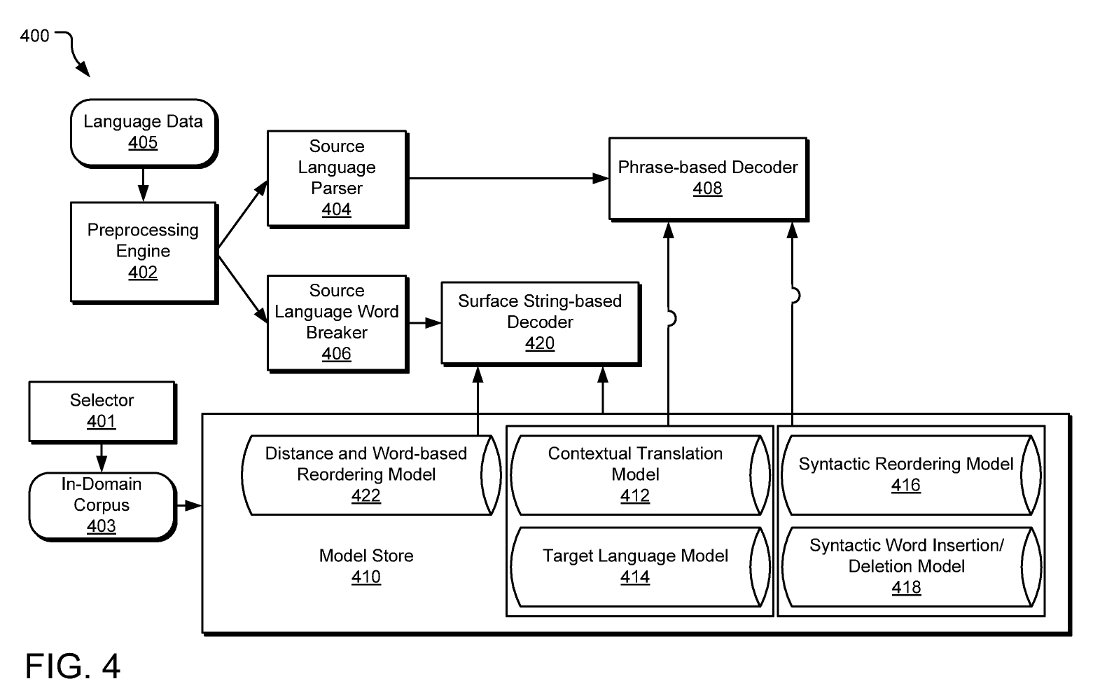

FIG. 4 illustrates an example machine translation system 400 using various language models trained using in-domain training data. While the machine translation system 400 illustrates one implementation where the in-domain training data is used, such in-domain training data is also used in a number of other systems, such as an Internet search processing system, a speech recognition system, a biological sequence processing system, etc.

A preprocessing engine 402 receives language data 405 for machine translation. For those languages having a language-specific source language parser (e.g., English, Spanish, Japanese, French, German, Italian, etc.), the corresponding candidate training data passes to a source language parser 404. The training data selected using the system disclosed herein can be used to train any other machine translation system, including any statistical machine translation system, even if it does not use a source language parser. The source language parser 404 performs syntactic analysis to identify dependencies between tokens (e.g., words) and to determine the grammatical structure of the candidate training data based on a given formal grammar. Thus, the source language parser 404 is used only in specific implementations and may not be required for other implementations of the machine translation system 400.

For the languages without a language-specific source language parser, the corresponding candidate training data passes to a source language word breaker 406. The source language word breaker 406 identifies sequences of tokens (e.g., words) without grammatical analysis. In one implementation, a phrase-based decoder 408, or other statistical machine translation decoder, receives the output of the source language parser 404 and decodes the phrase-based tree representing the candidate training data based on a variety of models accessed from a model store 410. Example models include, without limitation:
a contextual translation model 412, which contains bilingual word and phrase pairs and their contexts (e.g., surrounding words and phrases);
target language models 414, which estimate the probability of a possible translation output as a string of the target language;
a syntactic reordering model 416, which contains information about possible word orders in the target language and their probabilities; and
a syntactic word insertion/deletion model 418, which is used to decide whether words or phrases need to be removed or inserted in the target language output (e.g., to recover from the case of spontaneous words in the target language—those words having no equivalents in the source language).

In an alternative processing path, a surface string-based decoder 420 receives the output of the source language word breaker 406 and decodes the tokens extracted from the candidate training data based on a variety of models accessed from the model store 410. Example models may include without limitation:
a distance and word-based reordering model 422, which is used for ordering words in the target language output, for example where the order of the words diverges appreciably from the source language;
the contextual translation model 412; and
the target language model 414.

In one implementation, the various models in the model store 410 are trained on an in-domain training corpus 403. An implementation of the training corpus includes in-domain training data selected by an intelligent selector 401. For example, such in-domain training data is selected from a generic dataset by determining the cross-entropy of various data segments in such generic dataset. As a possible result of training with the in-domain training corpus 403, the machine translation system can achieve improved accuracy and/or lower computational requirements as compared to machine translation systems trained on arbitrary training datasets.

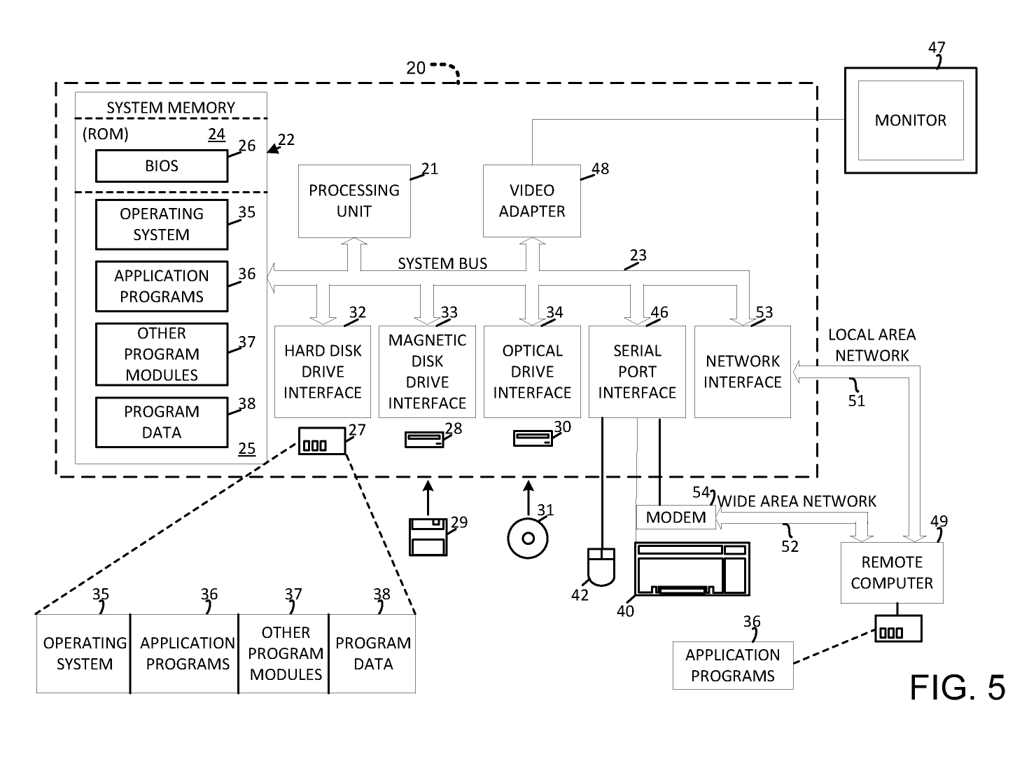

FIG. 5 illustrates an example system that may be useful in implementing the technology described herein. FIG. 5 illustrates an example system that may be useful in implementing the described technology. The example hardware and operating environment of FIG. 5 for implementing the described technology includes a computing device, such as general purpose computing device in the form of a gaming console or computer 20, a mobile telephone, a personal data assistant (PDA), a set top box, or other type of computing device. In the implementation of FIG. 5, for example, the computer 20 includes a processing unit 21, a system memory 22, and a system bus 23 that operatively couples various system components including the system memory to the processing unit 21. There may be only one or there may be more than one processing unit 21, such that the processor of computer 20 comprises a single central-processing unit (CPU), or a plurality of processing units, commonly referred to as a parallel processing environment. The computer 20 may be a conventional computer, a distributed computer, or any other type of computer; the invention is not so limited.

The system bus 23 may be any of several types of bus structures including a memory bus or memory controller, a peripheral bus, a switched fabric, point-to-point connections, and a local bus using any of a variety of bus architectures. The system memory may also be referred to as simply the memory, and includes read only memory (ROM) 24 and random access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program engines, and other data for the computer 20. It should be appreciated by those skilled in the art that any type of computer-readable media which can store data that is accessible by a computer, such as magnetic cassettes, flash memory cards, digital video disks, random access memories (RAMs), read only memories (ROMs), and the like, may be used in the example operating environment.

A number of program engines may be stored on the hard disk, magnetic disk 29, optical disk 31, ROM 24, or RAM 25, including an operating system 35, one or more application programs 36, other program engines 37, and program data 38. A user may enter commands and information into the personal computer 20 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20; the invention is not limited to a particular type of communications device. The remote computer 49 may be another computer, a server, a router, a network PC, a client, a peer device or other common network node, and typically includes many or all of the elements described above relative to the computer 20, although only a memory storage device 50 has been illustrated in FIG. 5. The logical connections depicted in FIG. 5 include a local-area network (LAN) 51 and a wide-area network (WAN) 52. Such networking environments are commonplace in office networks, enterprise-wide computer networks, intranets and the Internet, which are all types of networks.

When used in a LAN-networking environment, the computer 20 is connected to the local network 51 through a network interface or adapter 53, which is one type of communications device. When used in a WAN-networking environment, the computer 20 typically includes a modem 54, a network adapter, a type of communications device, or any other type of communications device for establishing communications over the wide area network 52. The modem 54, which may be internal or external, is connected to the system bus 23 via the serial port interface 46. In a networked environment, program engines depicted relative to the personal computer 20, or portions thereof, may be stored in the remote memory storage device. It is appreciated that the network connections shown are example and other means of and communications devices for establishing a communications link between the computers may be used.

In an example implementation, a selector, a language model, and other operators and services may be embodied by instructions stored in memory 22 and/or storage devices 29 or 31 and processed by the processing unit 21. Generic language data, in-domain language data, training data, and other data may be stored in memory 22 and/or storage devices 29 or 31 as persistent datastores. Further, a forwarding service and an ad service represent hardware and/or software configured to provide service functionality for network-connected systems. Such services may be implemented using a general-purpose computer and specialized software (such as a server executing service software), a special purpose computing system and specialized software (such as a mobile device or network appliance executing service software), or other computing configurations.

The embodiments of the invention described herein are implemented as logical steps in one or more computer systems. The logical operations of the present invention are implemented (1) as a sequence of processor-implemented steps executing in one or more computer systems and (2) as interconnected machine or circuit engines within one or more computer systems. The implementation is a matter of choice, dependent on the performance requirements of the computer system implementing the invention. Accordingly, the logical operations making up the embodiments of the invention described herein are referred to variously as operations, steps, objects, or engines. Furthermore, it should be understood that logical operations may be performed in any order, unless explicitly claimed otherwise or a specific order is inherently necessitated by the claim language.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
determining an in-domain cross-entropy of a data segment from a domain-specific dataset according to an in-domain language model;
determining a non-domain-specific cross-entropy of the data segment according to a non-domain-specific language model;
determining a difference between the in-domain cross-entropy and the non-domain-specific cross-entropy; and
adding the data segment to a training dataset for the in-domain language model, if the difference satisfies a threshold condition.

2. The method of claim 1 wherein the data segment is a text segment.

3. The method of claim 1 wherein the in-domain language model is a language model used for machine translation.

4. The method of claim 1 wherein the in-domain language model is at least one of (1) a language model used for speech recognition and (2) a search algorithm related language model.

5. The method of claim 1 wherein the non-domain-specific language model is a language model trained on a random sample of the non-domain-specific dataset.

6. One or more computer-readable storage media encoding computer-executable instructions for executing on a computer system a computer process, the computer process comprising:
scoring a data segment from a non-domain-specific dataset based on a difference between a cross-entropy of the data segment according to an in-domain language model and a cross-entropy of the data segment according to a non-domain-specific language model.

7. The one or more computer-readable storage media of claim 6 wherein the computer process further comprising adding the data segment to an in-domain training dataset for the in-domain language model, if the difference satisfies a threshold condition.

8. The one or more computer-readable storage media of claim 6 wherein the data segment is a text segment.

9. The one or more computer-readable storage media of claim 6 wherein the data segment is a segment of a biological sequence.

10. The one or more computer-readable storage media of claim 6 wherein the in-domain language model is a language model used for machine translation.

11. The one or more computer-readable storage media of claim 6 wherein the in-domain language model is an n-gram language model.

12. The one or more computer-readable storage media of claim 6 wherein the non-domain-specific language model is a language model trained on a random sample of the non-domain-specific dataset.

13. The one or more computer-readable storage media of claim 6 wherein the computer process further comprising partitioning the non-domain-specific dataset into the data segments, each data segment being a sentence.

14. The one or more computer-readable storage media of claim 6 wherein the computer process further comprising determining the difference in a log domain.

15. The one or more computer-readable storage media of claim 7 wherein the non-domain-specific dataset comprising a first component in a first language and a second component in a second language and wherein scoring the data segment from the non-domain-specific dataset further comprising scoring the first component.

16. The one or more computer-readable storage media of claim 15 wherein adding the data segment to the in-domain training dataset for the in-domain language model further comprising adding the first component and the second component to the in-domain training dataset for the in-domain language model.

17. A system comprising:
a selection engine configured to select a text segment from a non-domain-specific dataset;
a determination engine configured to determine an in-domain cross-entropy of the text segment according to an in-domain language model and to determine a non-domain-specific cross-entropy of the text segment according to a non-domain-specific language model; and
a differentiator configured to determine a difference between the in-domain cross-entropy and the non-domain-specific cross-entropy.

18. The system of claim 17 further comprising a comparator configured to compare the difference with a threshold.

19. The system of claim 18 wherein the comparator is further configured to add the data segment to a training dataset for the in-domain language model, if the difference satisfies a threshold condition.

20. The system of claim 17 wherein the non-domain-specific language model is a language model trained on a random sample of the non-domain-specific dataset.
